(19) United States
(12) Patent Application Publication
(10) Pub. No.: US 2001/0054335 A1
(43) Pub. Date: Dec. 27, 2001

(54) Self-adjusting vise-grip wrench

(76) Inventor: Wes F. Harman, Harrisonburg, VA (US)

Correspondence Address: Richard C. Litman, LITMAN LAW OFFICES, LTD., P.O. Box 15035, Arlington, VA, 22215, US

(21) Appl. No.: 09/885,108

(22) Filed: Jun. 21, 2001

Related U.S. Application Data
(60) Provisional application No. 60/212,817, filed on Jun. 21, 2000.

(51) Int. Cl. B25B 7/12

(52) U.S. Cl. 81/367

(57) ABSTRACT

A modified self-adjusting vise-grip wrench implemented by replacing the conventional set screw element with two embodiments of a spring-loaded replacement set screw and slide pin or push rod element device.

### CROSS-REFERENCE TO RELATED APPLICATION

This application claims the benefit of U.S. Provisional Patent Application Ser. No. 60/212,817, filed Jun. 21, 2000.

### BACKGROUND OF THE INVENTION

1. FIELD OF THE INVENTION

The present invention relates generally to wrenches. More specifically, the present invention is a modified self-adjusting vise-grip wrench implemented by replacing the conventional set screw element with a spring-loaded replacement set screw and slide pin or push rod element.

2. DESCRIPTION OF RELATED ART

The related art of interest describes various self-adjusting locking wrenches, but none discloses the present invention. There is a need for a self-adjusting vise-grip insert for modifying conventional vise grip wrenches The relevant art will be discussed in the order of perceived relevance to the present invention.

U.S. Pat. No. 2,471,734 issued on May 31, 1949, to Friedriech C. Fischer describes a toggle operated slidable jaw wrench or a C-clamp comprising a spring-loaded adjustment pin disposed within the fixed offset handle that pushes a slide pin or presetting shaft backwards and the movable jaw to close as a gripping force is applied to an object. The rotation of the presetting shaft to adjust the movable jaw relative to the fixed jaw to fit an object is conventional. The slidable jaw wrench is distinguishable for its manual jaw closure adjustment feature.

U.S. Pat. No. RE. 32,614 issued on Mar. 1, 1988, a reissue of U.S. Pat. No. 4,499,797 issued on Feb. 19, 1985, to Neill R. Wilson describes a self-adjusting locking wrench having force control lever positioned above the jaws and interlocking with the lower jaw. U.S. Pat. No. 3,710,658 issued to Jan. 16, 1973, for the same inventor describes a self-adjusting locking wrench without the force control lever. These wrenches require the positioning of the pliers jaw opening adjustment screw at the end of the handle. The self-adjusting locking wrenches are distinguishable for the conventional jaw opening adjustment screws.

U.S. Pat. No. 2,997,903 issued on Aug. 29, 1961, to Reiner Rommel et al. describes a pair of vise grip pliers with a self-adjusting toggle means comprising a spring-loaded sleeve sliding on a bar guide adjacent the handle. The sleeve is pivotally joined by a lever arm to the handle with a release lever. A set screw is positioned proximate the end of the lever arm in one embodiment. The pliers is distinguishable for its movable spring-loaded sleeve.

U.S. Pat. No. 2,499,201 issued on Feb. 28, 1950, to Norman C. Thayer describes an automatic toggle actuated grip wrench comprising a steel bar with an external slotted end in the handle. The bar adjusts the range of the toggle link. The bar is encircled by a coil spring and adjustable in inward or outward travel in rotation by utilizing a screwdriver to drive the bar. The wrench is distinguishable for its required external manual adjustment of the bar by a screwdriver.

U.S. Pat. No. 2,501,238 issued on Mar. 21, 1950, to Hershel B. Sarsgard et al. describes a plier-type article-holding clamp having a spring-pressed jaw comprising an upper jaw with spring actuated clamping means. Two toggle arms are handles which compress the jaws. The pliers clamp device is distinguishable for its spring actuated clamping member.

U.S. Pat. No. 2,589,511 issued on Mar. 18, 1952, to Charles H. Redmon describes a release mechanism for a toggle actuated plier type wrench comprising a fulcrum bar pivoting on one end and contacting the adjusting screw in the distal end of the channeled fixed jaw. Another adjusting screw in the channeled movable jaw contacts a lug on the fulcrum bar. A spring tends to maintain the spreading of the jaws and the contact between the fulcrum and the adjusting screw in the fixed lower handle. The release mechanism is distinguishable for its requirement for the conventional adjusting screw in the handle of the fixed jaw of the wrench.

U.S. Pat. No. 936,980 issued on Oct. 12, 1909, to Arnold Bing describes tongs comprising a movable upper jaw held by two side plates to a lower gripping jaw having a gripping handle and a movable handle. The movable jaw has a tension rod encased partially in a spiral spring held by a sliding ring linked to the upper end of the movable handle. A collar with a set screw adjacent the sliding ring adjusts the tension of the spring. The gripping handle has a collar on a guide which fits on the tension rod. The tongs are distinguishable for the manual adjustment of tension for closing the jaws.

German Patent Application No. DE 30 00 555 A1 published on Jul. 16, 1981, for Rudolf Wehrli describes a clamping tool for two work pieces comprising a conventional collet chuck with clamping studs on its chuck jaws. The clamping tool is distinguishable for lacking an adjustable locking means.

U.K. Patent Application No. 1,280,557 published on Jul. 5, 1972, for George W. Peters describes an adjustable clamping tool comprising an upper jaw movable in the U-section body of the lower jaw. The self-locking toggle is connected to a thrust block acting as a sleeve for the pull rod connected to the upper jaw. The pull rod has a threaded end travelling in the thrust block and an adjustable nut for clamping an object. The tool is distinguishable for having a conventional set screw adjustment.

None of the above inventions and patents, taken either singly or in combination, is seen to describe the instant invention as claimed.

### SUMMARY OF THE INVENTION

The invention is a modified self-adjusting vise-grip wrench implemented by replacing the conventional set screw element with a spring-loaded replacement set screw and slide pin element or a push rod. A vise-grip wrench with pliers jaws or C-clamp jaws can be produced with this modification. It is within the scope of this invention to produce a vise-grip wrench including the self-adjusting vise-grip element.

Accordingly, it is a principal object of the invention to provide a retrofitting self-adjusting vise-grip insert element.

It is another object of the invention to provide a retrofitting self-adjusting vise grip insert element to replace the conventional hand adjustable set screw element of a vise-grip wrench.

It is a further object of the invention to provide a set screw replacement consisting of an adjustment slide pin or push rod having a high strength extension spring and a replacement set screw.

Still another object of the invention is to provide a self-adjusting locking pliers having either pliers jaws or C-clamp jaws with the self-adjusting vise-grip insert.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a self-adjusting vise-grip device of a first embodiment insert installed in a wrench according to the present invention.

FIG. 2 is an enlarged elevational side view of the first embodiment insert device.

FIG. 3 is an exploded elevational view of the parts of the first embodiment insert device.

FIG. 4 is an elevational view of a second embodiment of an insert device for the self-adjusting vise-grip wrench.

FIG. 5 is an exploded elevational view of the parts of the second embodiment insert device.

Similar reference characters denote corresponding features consistently throughout the attached drawings.

### DETAILED DESCRIPTION OF THE PREFERRED EMBODIMENTS

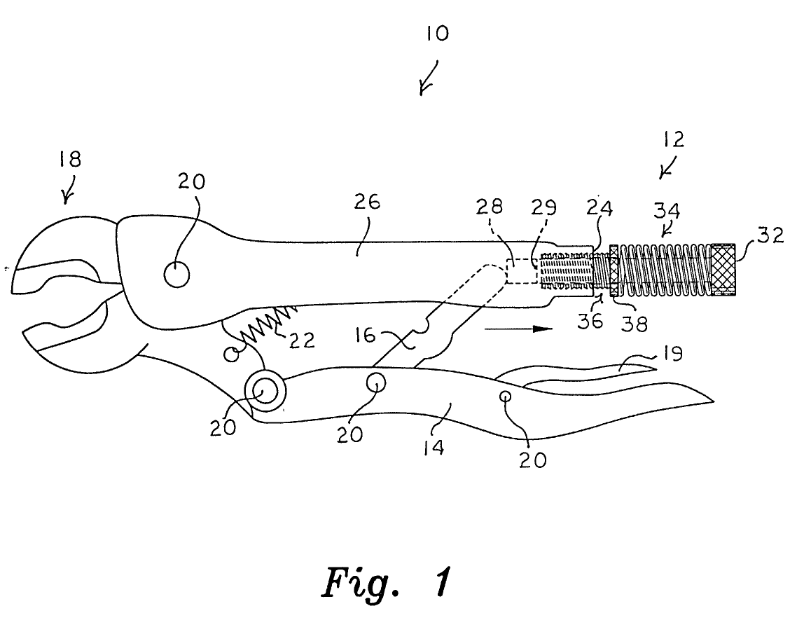

The present invention is directed to a self-adjusting vise-grip wrench and two embodiments of a self-adjusting vise-grip insert device. In FIG. 1, a conventional vise grip wrench 10 has been modified with a first embodiment of the self-adjusting vise-grip insert or replacement device 12. The handle 14 is connected to a pressure lever 16 which contacts the inside end of the insert 12. The jaws 18, the release lever 19, pivot pins 20, and return spring 22 are conventional. A port 24 at the distal end of the main body 26 of the wrench 10 is internally threaded to receive the insert device 12.

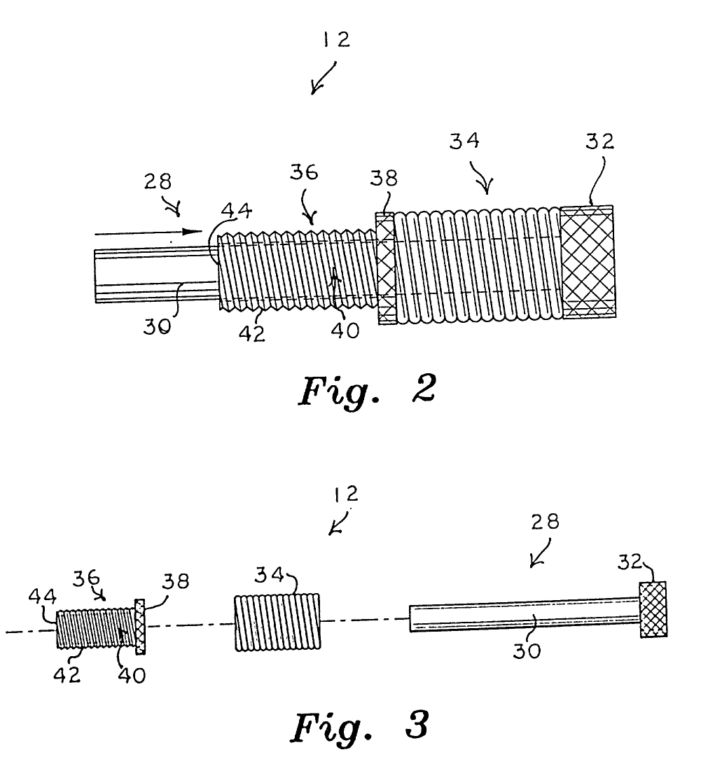

In FIGS. 2 and 3 depicting the first embodiment insert device 12, a slide pin element 28 having a long cylindrical body 30 of a first diameter and a short cylindrical head 32 of a larger second diameter is illustrated. An extension spring 34 having a high strength is adapted to snugly fit the slide pin's body 30, and one end is welded to the slide pin's head 32. A replacement set screw 36 having an apertured cylindrical head 38 of the first external diameter abuts and is welded to the opposite end of the extension spring 34. The set screw 36 has a cylindrical body 40 with external threading 42 of a third external diameter and an internal throughbore 44 of the first diameter.

The self-adjusting vise-grip replacement device 12 is inserted in a conventional vise-grip wrench 10 for enabling the wrench to be self-adjusting in gripping and holding a pipe, a nut and the like object without resorting to rotation of the slide pin as is required with conventional vise-grip wrenches. The diameter of the port 24 at the end of the vise-grip handle 14 can have a different size due to various sizes of a conventional vise-grip wrench requiring the use of an appropriate sized replacement insert device 12.

An advantage of the vise-grip wrench 10 is that the gripping force has a range of applied pressure due to the extension spring 34.

With reference to FIG. 1, a shortened slide pin 29 is depicted to include an embodiment wherein the pressure lever 16 abuts the shortened end of pin 29 adjacent the end of the set screw 36 to prevent any yielding of the extension spring 34 when the worker must twist the gripped workpiece.

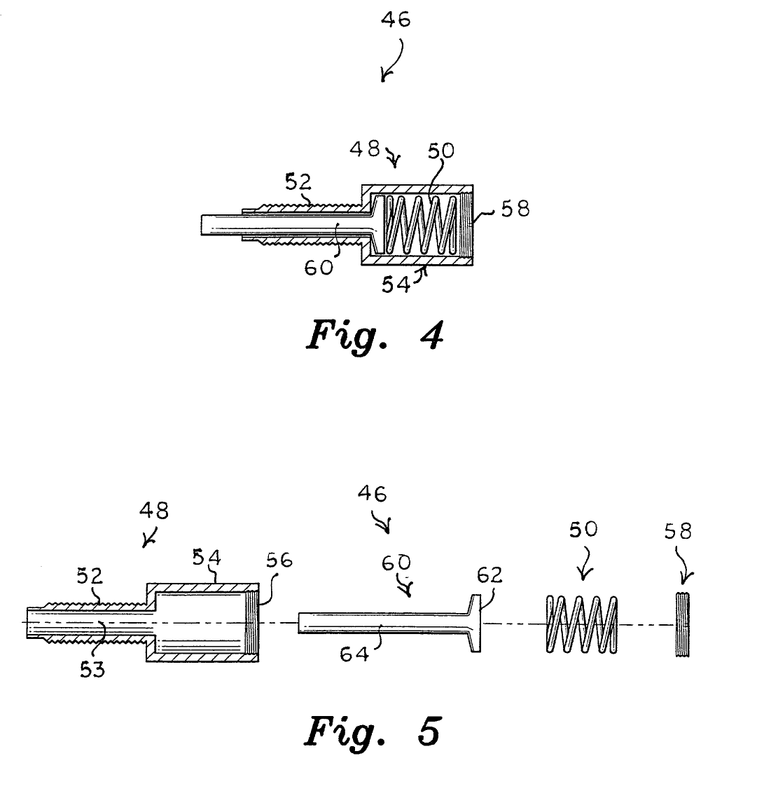

A second embodiment of a self-adjusting vise-grip insert device 46 is illustrated in FIGS. 4 and 5 which incorporates a cylindrical housing 48 for the extension spring 50. The housing 48 has an externally threaded neck portion 52 with a throughbore 53, and a main housing portion 54 having internal threading 56 at its large opening for closing the main housing portion 54 with an externally threaded end cap 58 after a push rod 60 having a broad circular head 62 and a cylindrical shaft 64 has been inserted within the high strength extension spring 50. The spring 50 can be welded to the head 62 of the push rod 60. The external surface of the main housing portion 54 can be knurled (not shown) for more effective gripping. The end cap 58 can have an external slot (not shown) for insertion or removal by a screwdriver. This self-adjusting vise-grip insert device 46 accomplishes the same beneficial effect on the performance of the pliers 18 as in the first embodiment when inserted in the handle 14 to automatically adjust the jaw spacing.

It should be noted that the modified vise-grip wrench can have conventional pliers' jaws 18 or C-clamp jaws. Furthermore, a modified vise-grip wrench with the inventive self-adjusting feature can be manufactured as such instead of retrofitting the insert devices 12 and 46.

It is to be understood that the present invention is not limited to the embodiments described above, but encompasses any and all embodiments within the scope of the following claims.

I claim:

1. A self-adjusting vise-grip replacement device for a vise-grip wrench comprising:
a cylindrical housing made up of a main hollow housing portion and a neck portion having a reduced diameter;
said main hollow housing portion having an open end with an internally threaded region;
said neck portion having an externally threaded region adjacent the main hollow housing portion;
a push rod having an extended planar circular head and a cylindrical shaft adapted to be inserted in the main hollow housing portion and the neck portion;
an extension spring positioned inside the main hollow housing portion and abutting the planar circular head of the push rod; and
a circular cap adapted to close the open end of the main housing portion.

2. The device according to claim 1, wherein said main hollow housing portion has an open end with an internally threaded region.

3. The device according to claim 2, wherein said circular cap has an externally threaded periphery for closing the open end of the main housing portion.

4. The device according to claim 1, wherein the extension spring is welded to the push rod's head.

5. A conventional vise-grip wrench modified with a self-adjusting vise-grip replacement device comprising:
a conventional vise-grip wrench without its set screw portion modified with a cylindrical housing, which is made up of a main hollow housing portion and a neck portion having a reduced diameter;
said main hollow housing portion having an open end with an internally threaded region;
said neck portion having an externally threaded region adjacent the main hollow housing portion;
a push rod having an extended planar circular head and a cylindrical shaft adapted to be inserted in the main hollow housing portion and the neck portion;
an extension spring positioned inside the main hollow housing portion and abutting the planar circular head of the push rod; and
a circular cap having an externally threaded region adapted to close the open end of the main housing portion.

6. The modified vise-grip wrench according to claim 5, wherein the vise-grip wrench can have conventional pliers jaws or C-clamp jaws.

7. The modified vise-grip wrench according to claim 5, wherein the extension spring is welded to the head of the push rod.

8. The modified vise-grip wrench according to claim 5, wherein the replacement device is sized to fit existing pliers.

9. A self-adjusting vise-grip replacement device for a vise grip wrench comprising:
a slide pin element having a long cylindrical body of a first internal diameter and a short cylindrical head of a larger second diameter;
an extension spring having a high strength adapted to snugly fit the slide pin's body; and
a replacement set screw having an apertured cylindrical head of the first external diameter and a cylindrical body with external threading of a third external diameter and an internal throughbore of the first internal diameter to abut the extension spring;
whereby inserting the self-adjusting vise-grip replacement in a conventional vise-grip wrench for enabling the modified wrench to be self-adjusting in gripping articles without resorting to rotation of the slide pin.

10. The self-adjusting vise-grip replacement device according to claim 9, wherein the vise-grip wrench can have conventional pliers jaws or C-clamp jaws.

11. The self-adjusting vise-grip replacement device according to claim 9, wherein the extension spring is welded to the slide pin's head.

12. The self-adjusting vise-grip replacement device according to claim 9, wherein the replacement device is sized to fit existing pliers.

13. A conventional vise-grip wrench modified with a self-adjusting vise-grip replacement device comprising:
a conventional vise-grip wrench without its set screw element and replacement of a self-adjusting vise-grip device comprising;
a slide pin element having a long cylindrical body of a first internal diameter and a short cylindrical head of a larger second diameter;
an extension spring having a high strength adapted to snugly fit the slide pin's body; and
a replacement set screw having an apertured cylindrical head of the first external diameter and a cylindrical body with external threading of a third external diameter and an internal throughbore of the first internal diameter to abut the extension spring;
whereby inserting the self-adjusting vise-grip replacement in a conventional vise-grip wrench for enabling the modified wrench to be self-adjusting in gripping articles without resorting to rotation of the slide pin.

14. The modified vise-grip wrench according to claim 13, wherein the vise-grip wrench can have conventional pliers jaws or C-clamp jaws.

15. The modified vise-grip wrench according to claim 13, wherein the extension spring is welded to the slide pin's head.

16. The modified vise-grip wrench according to claim 13, wherein the replacement device would be sized to fit existing pliers.
